(19) United States
(12) Patent Application Publication
(10) Pub. No.: US 2026/0194746 A1
(43) Pub. Date: Jul. 9, 2026

(54) WEATHERIZED OPTICAL OBSERVING SYSTEM

(71) Applicant: Astronomy Data Processing Corporation, Adrian, MI (US)

(72) Inventors: Daniel John Roelker, Bluemont, VA (US); Richard Lee Hedrick, Adrian, MI (US); Kevin Andrew Iott, Adrian, MI (US); Connor Dinsmore Poole, Los Angeles, CA (US); Dominic Loubert, Adrian, MI (US); Joseph Christopher Lake, Dundee, MI (US); Jason Wang, Los Angeles, CA (US)

(21) Appl. No.: 19/443,779

(22) Filed: Jan. 8, 2026

Related U.S. Application Data
(60) Provisional application No. 63/743,544, filed on Jan. 9, 2025.

(51) Int. Cl. G02B 27/00; G02B 23/16

(52) U.S. Cl. CPC G02B 27/0006; G02B 23/16

(57) ABSTRACT

A weatherized optical observing system includes components that include an optical telescope, a gimbal, and an integrated controller. The optical telescope includes an imaging device configured to capture telescope images. The gimbal is configured to move the optical telescope in at least two axes. The integrated controller configured to wirelessly transmit the telescope images, wirelessly receive instructions, identify local weather data, actuate the gimbal based on the instructions, and control the optical telescope based on at least one of the instructions or the local weather data.

### RELATED APPLICATION

This application claims benefit of U.S. Provisional App. No. 63/743,544, filed January 9, 2025, the contents of which are hereby incorporated by reference in their entirety.

### TECHNICAL FIELD

Embodiments of the present disclosure relate to observing system, and in particular to weatherized optical observing systems.

### BACKGROUND

Telescopes are used to observe distance objects. Telescopes may be used to observe objects based on the objects’ emission, absorption, and/or reflection of electromagnetic radiation.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-C illustrate weatherized optical observing systems, according to certain embodiments.

FIG. 2 illustrates a system of weatherized optical observing systems, according to certain embodiments.

FIGS. 3A-D illustrate weatherized optical observing systems, according to certain embodiments.

FIG. 4 is a flow chart of a method associated with a weatherized optical observing system, according to certain embodiments.

FIG. 5 is a block diagram illustrating a computer system, according to certain embodiments.

### DETAILED DESCRIPTION OF EMBODIMENTS

Embodiments described herein are related to weatherized optical observing systems (e.g., weatherized optical observing devices, fully vertically integrated weatherized optical observing systems).

Telescopes are used to observe distance objects. Telescopes may be used to observe objects based on the objects’ emission, absorption, and/or reflection of electromagnetic radiation.

Conventionally to use a telescope, a user is to purchase a telescope, and mount to hold the telescope, a pier to hold the mount, and a concrete pad to hold the pier too. Also conventionally needed is a focuser, adapters and spacers and a specialized astronomy camera and filter wheel. Then, conventionally, the user needs to purchase an enclosure or build a building to house the telescope to protect the telescope from the weather. Conventionally, telescopes are to be manually covered (e.g., by closing a roof of a building, by a tarp, etc.) responsive to adverse weather conditions. Conventionally, telescopes are infrequently used (e.g., to avoid damaging the telescope) or are used and undergo damage (e.g., due to moisture).

After that, conventionally, different sets of software are needed to control each of the devices which include the telescope fans, heaters, focuser, de-rotator and the mount that holds and points the telescope. Conventionally, the camera and filter wheel require another software package. Conventionally, the weather station needs even another software package and the enclosure needs yet another software package. Then, conventionally, software for planning the observing session and software for processing the images is needed. Each of the sets of software are to be updated separately and troubleshooted to work together. If the telescope system is used remotely, conventionally, the user will also need a remote power strip in order to cycle the power on individual accessories.

The present disclosure may overcome shortcomings of conventional systems.

In some embodiments, a weatherized optical observing system includes components that include an optical telescope, a gimbal, and an integrated controller. The optical telescope includes an imaging device configured to capture telescope images. The gimbal is configured to move the optical telescope in at least two axes. The integrated controller configured to wirelessly transmit the telescope images, wirelessly receive instructions, identify local weather data, actuate the gimbal based on the instructions, and control the optical telescope based on at least one of the instructions or the local weather data.

The present disclosure may provide an optical observing system (e.g., weatherized optical observing system, weatherized optical observing system) that is a ground-based telescope for astronomy and all space observations. This present disclosure may include multiple components (e.g., two or more of telescope, mount to hold and point the telescope, pier to hold the mount, pad to hold the pier, focuser, adapters, spacers, astronomy camera, filter wheel, enclosure and/or building and/or housing, software, telescope fans, heaters, focuser, de-rotator, weather station, remote power strip, etc.) together in one product. The present disclosure may also remove the need to purchase an enclosure or build a building to house the telescope system. The present disclosure may not require a concrete pad. The telescope system (e.g., weatherized optical observing system) of the present disclosure may be pre-commissioned and come in a crate which can be set down, opened, and then the telescope system may be used.

The present disclosure has advantages over conventional solutions. The present disclosure may include more components commissioned and controlled together (e.g., by common software, common integrated controller) than conventional solutions. The present disclosure may take less time from delivering to starting up than conventional solutions. The present disclosure may have a weatherized optical observing system that can be placed in more places (e.g., outside, front yard, back yard, without a building to house the telescope, etc.) than conventional solutions. The present disclosure may automatically protect (e.g., cover, seal, etc.) components during adverse weather conditions to allow using the weatherized optical observing system more often and better prevent damage (e.g., entrance of moisture) compared to conventional solutions.

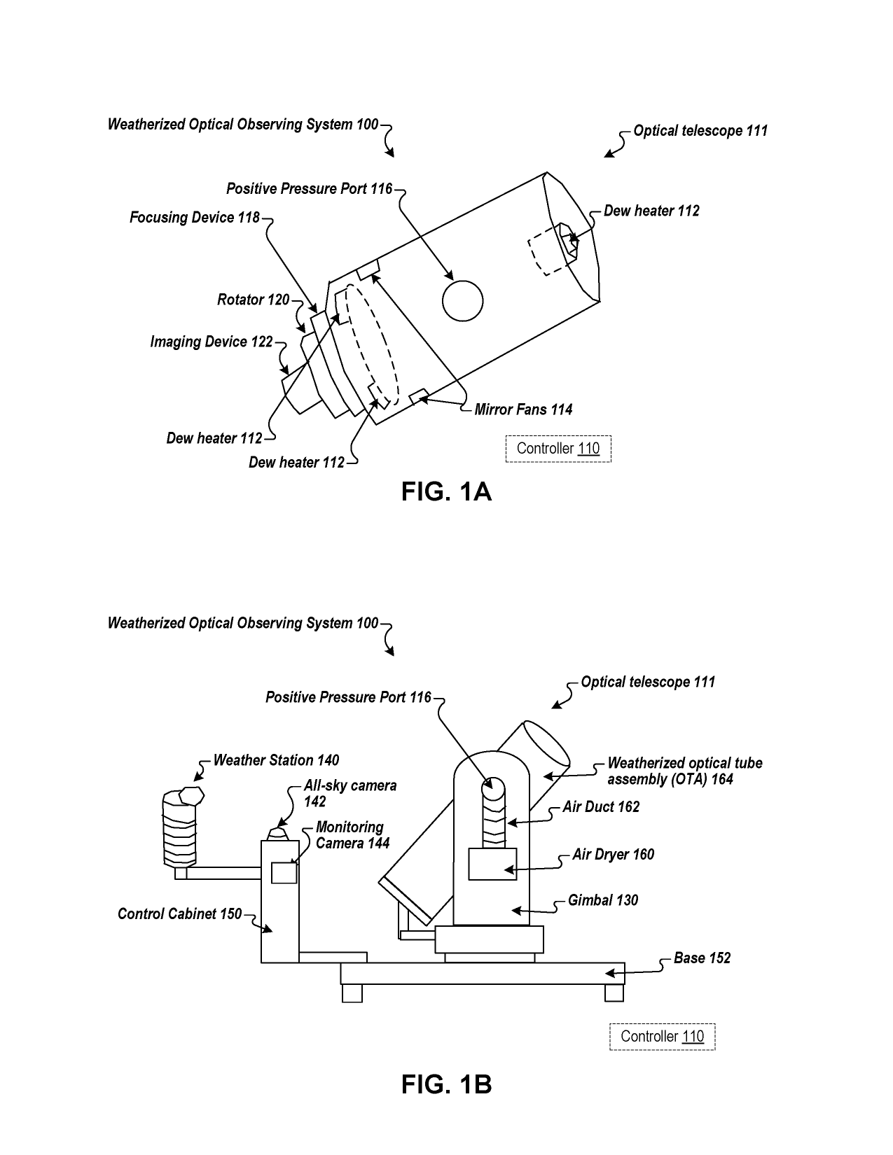

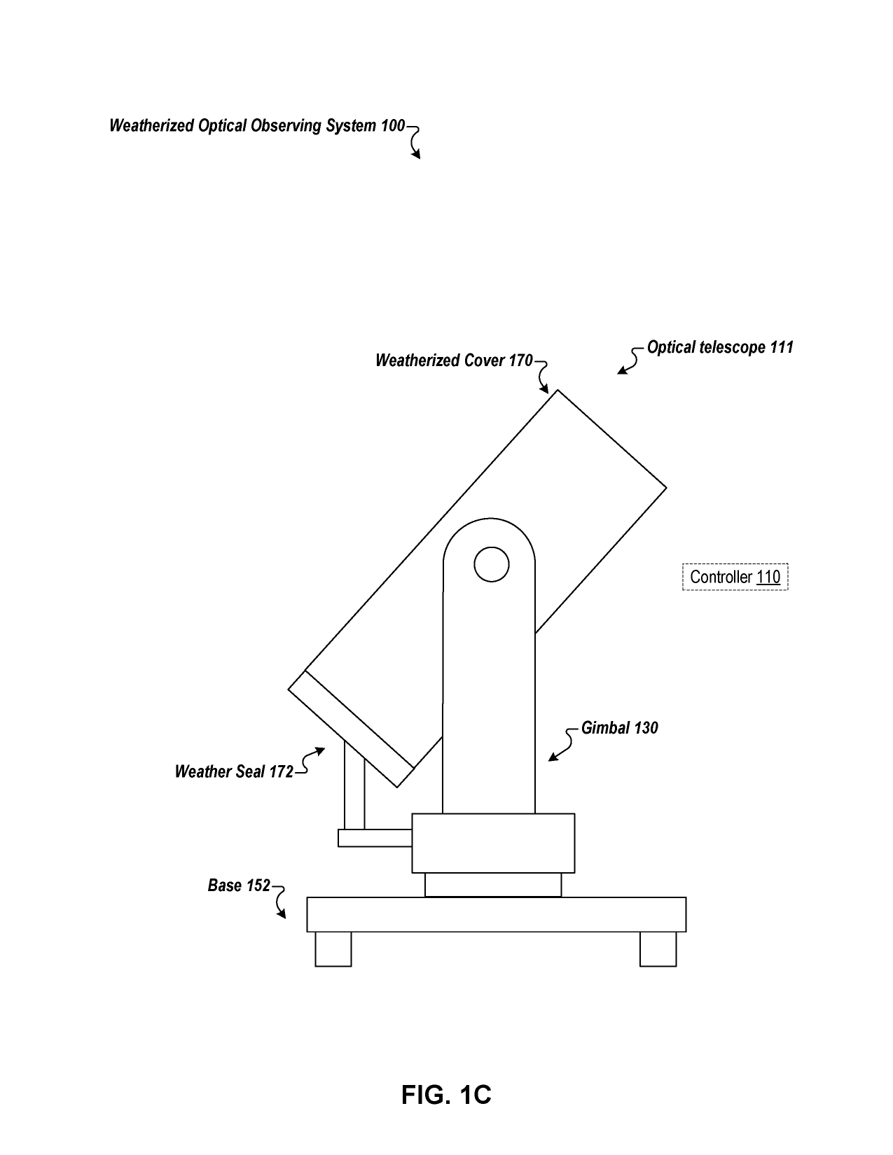

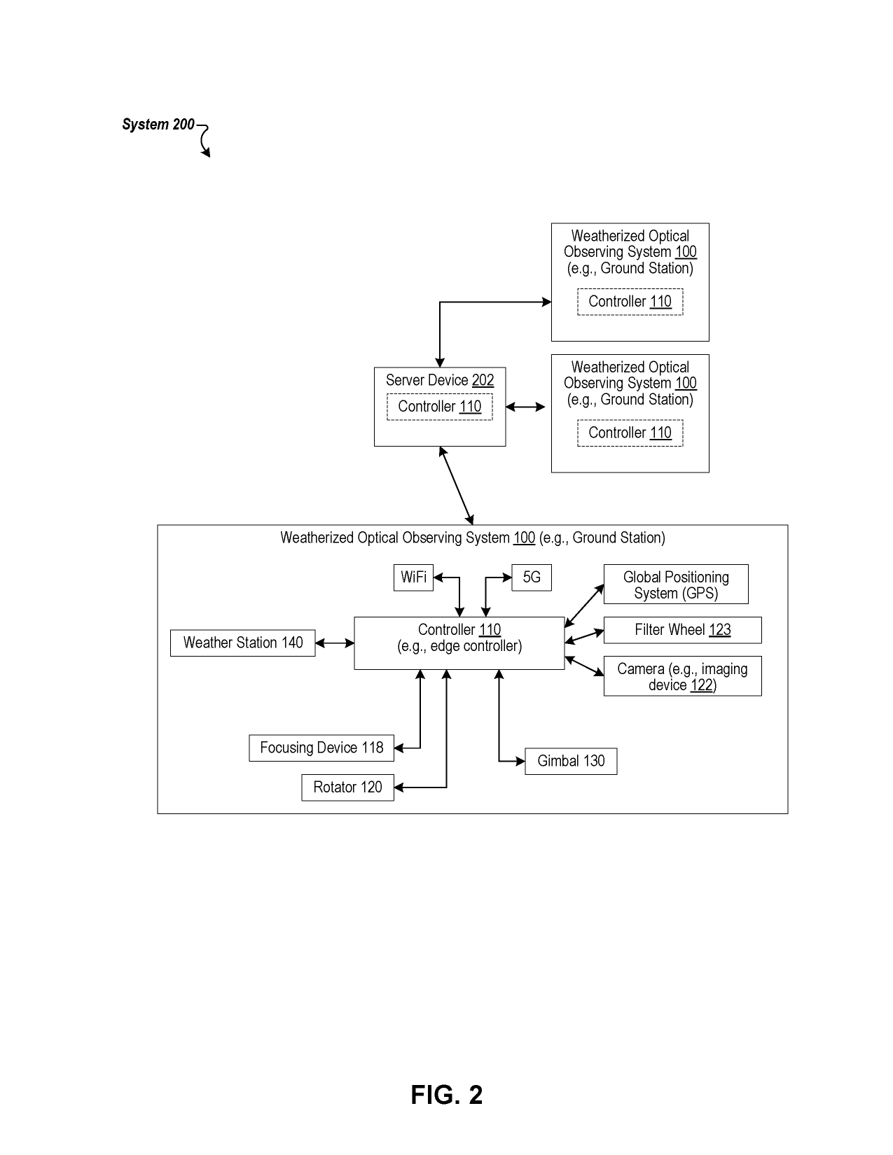

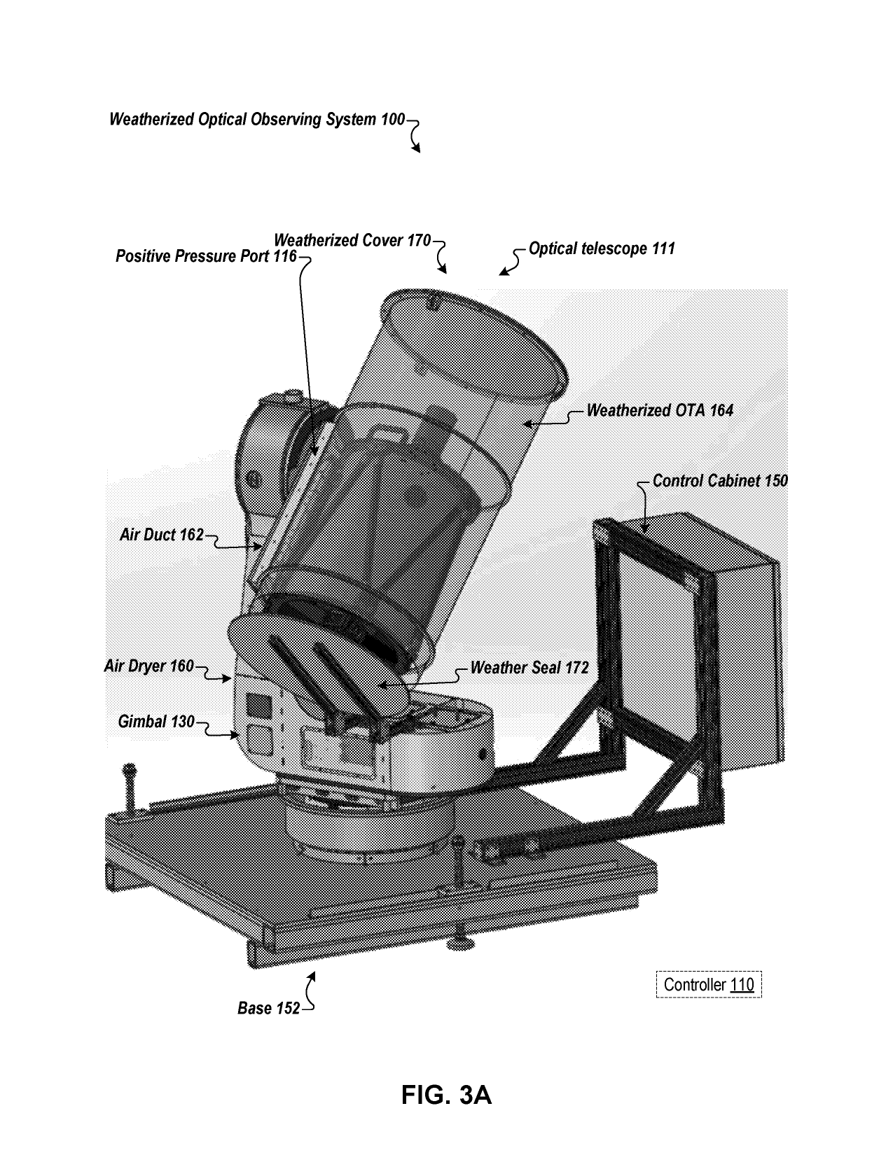

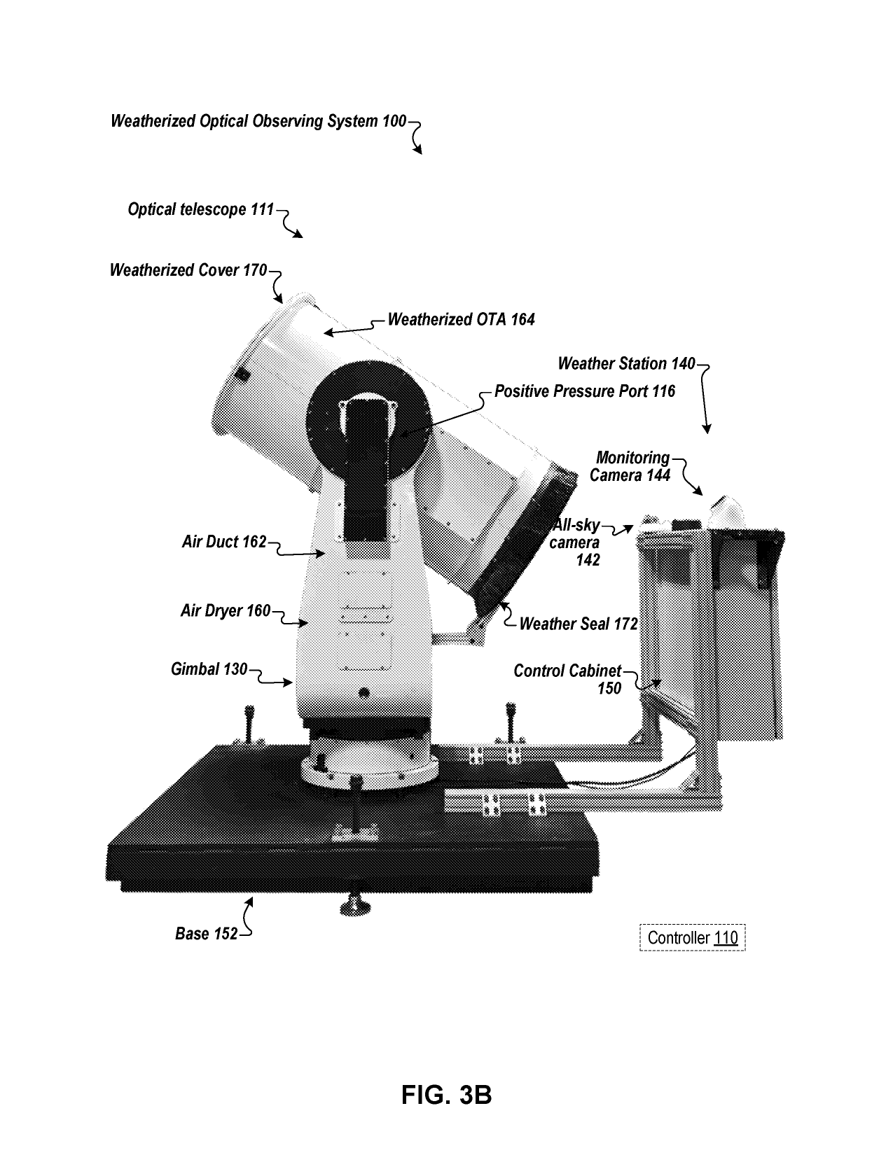

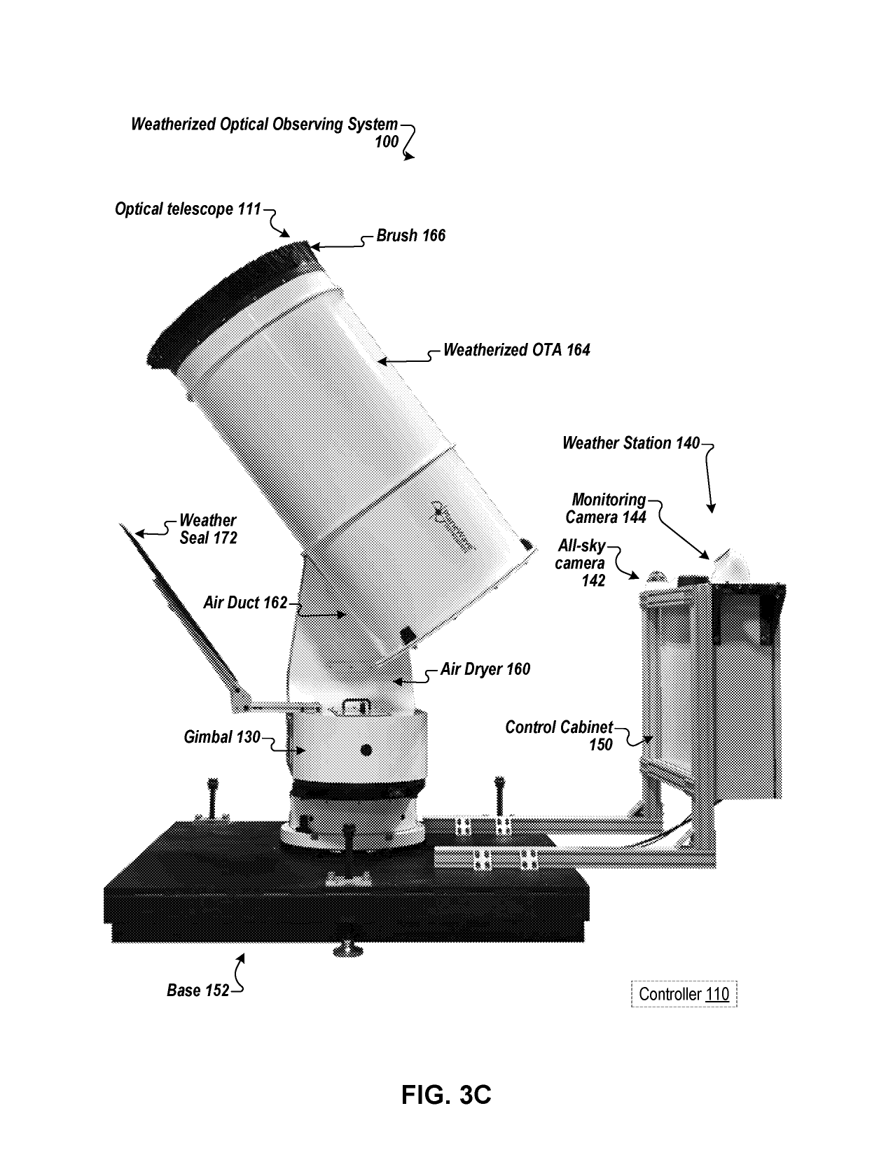

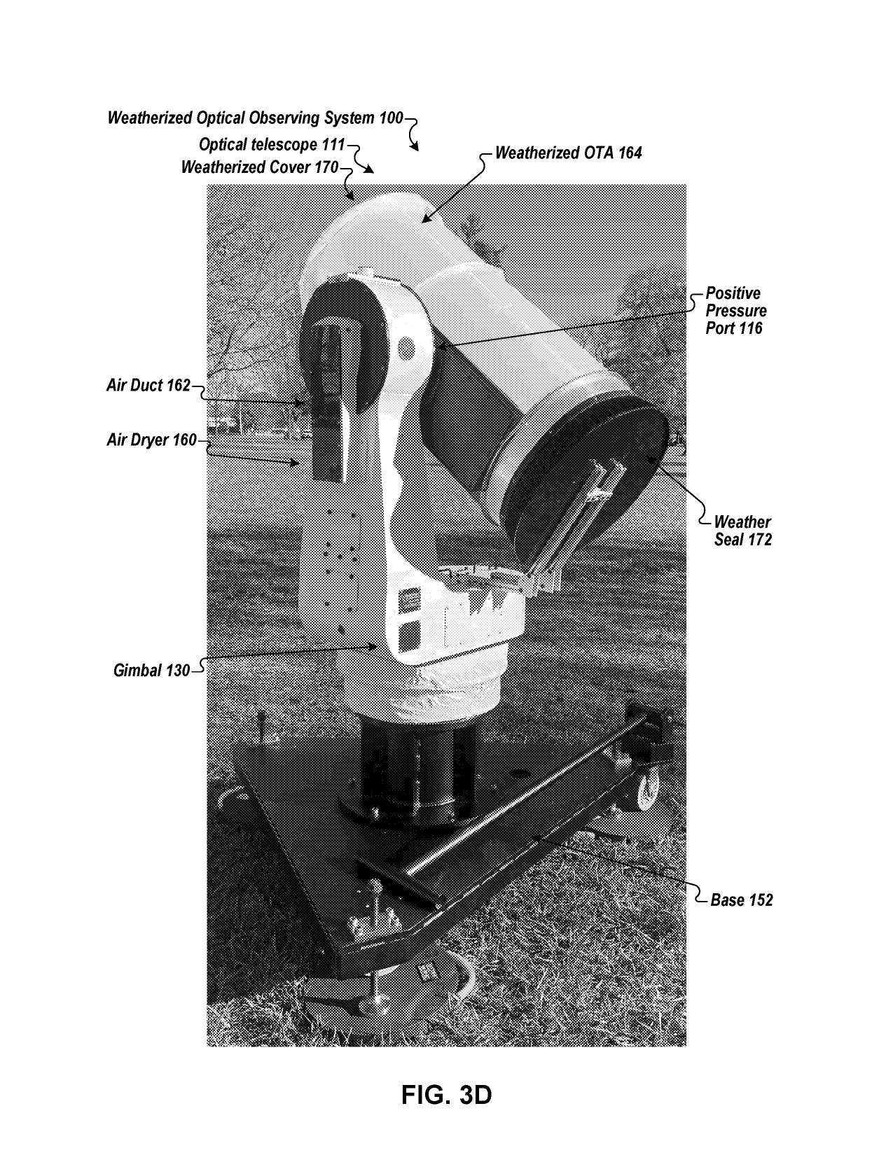

FIGS. 1A-C illustrate weatherized optical observing systems 100, according to certain embodiments. FIG. 2 illustrates a system 200 of weatherized optical observing systems 100, according to certain embodiments. FIGS. 3A-D illustrate weatherized optical observing systems 100, according to certain embodiments.

The weatherized optical observing system 100 of the present disclosure may include an optical telescope 111.

The optical telescope 111 may include one or more of: dew heaters 112; mirror fans 114; and/or positive pressure port 116 (e.g., positive-pressure fans); focusing device 118 (e.g., focuser); rotator 120; and/or imaging device 122 (e.g., camera, sensor).

A gimbal 130 (e.g., two-axis gimbal, two axis gimbal weatherized) may be coupled to and configured to move the optical telescope 111 in at least two axes.

The optical telescope 111 may include a weatherization cover 170 (e.g., weatherized telescope cover) for the telescope and sensor package. The weatherized optical observing system 100 may include one or more weather seals 172 (e.g., home position weather seal, see FIG. 1C).

The focusing device 118 may be configured to move the imaging device 122 to the focal plane (e.g., of the optical telescope 111) or to move the focal plane to the imaging device 122.

The rotator 120 (e.g., de-rotator) may be configured to correct for field rotation caused by an alt-az tracking system tracking equatorial objects.

The optical telescope 111 may include a filter wheel 123 (FW) for the imaging device 122 (e.g., sensor);

The weatherized optical observing system 100 may include a weather station 140.

The weatherized optical observing system 100 may include a dehumidifier and positive air flow fan system configured to keep optics clean and prevent dew on the mirrors (e.g., primary and secondary mirrors);

The weatherized optical observing system 100 may include a controller 110 (e.g., integrated controller, embedded controller, central controller, etc.) configured to control all of the above electronics.

The weatherized optical observing system 100 may include a Secondary Controller for which all electronics can be switched on and off.

The weatherized optical observing system 100 may include one or more Optical Controller(s) (e.g., a corresponding processing device) for which the dehumidifier, positive air-flow system, rotator 120 (e.g., de-rotator), focusing device 118 (e.g., focuser), optical tube assembly (OTA) Fans, and/or dew heaters 112 can be autonomously controlled.

The weatherized optical observing system 100 may include an all-sky camera 142 (e.g., as part of the weather station 140, separate from the weather station 140).

The weatherized optical observing system 100 may include a monitoring camera 144.

The weatherized optical observing system 100 may include a control cabinet 150. Controller 110 may be located in the control cabinet 150.

The weatherized optical observing system 100 may include a base 152 (e.g., steel pallet base).

The weatherized optical observing system 100 may include an air dryer 160 and an air duct 162 coupled between the air dryer 160 and the positive pressure port 116.

The weatherized optical observing system 100 may include a weatherized OTA 164.

The weatherized optical observing system of the present disclosure may include features that include:

Simple deployment including one or more of: Crate arrives; Set crate in desired location for system; Remove the crating from the base; Remove shipping safety restraints; and/or Plug in power;

Central Controller (e.g., integrated controller) automatically aligns itself to the sky (e.g., meaning the central controller automatically defines the alt-az to equatorial coordinate transformation);

Central Controller automatically discovers the horizon of the local observing location;

Central Controller focuses automatically continuously during operation;

Central Controller points to objects automatically;

Central Controller automates capture of Flat, Dark, and Bias frames;

Central Controller detects local weather (e.g., based on local weather data from the weather station of the weatherized optical observing system) to determine if conditions are acceptable for operation (e.g., determines based on local weather station AND via continuous all-sky imagery);

Central Controller communicates with the cloud for storage, remote control, advanced scheduling, and additional image processing;

Web interface is served from the controller for internet disconnected access and usage (e.g., when the internet is available control is managed through a central web interface);

Central Controller performs automated planning for the observations of the evening use (e.g., when connected to the internet for advanced planning, interrupts for events can be sent to the system; when connected to the internet for advanced planning, joint observations of astronomical objects and sky regions can be distributed across multiple users);

Central Controller can use multiple sources of internet (e.g., Integrated 5G, Wi-Fi®; and/or and ethernet);

Central Controller broadcasts Wi-Fi® hotspot for use in fully remote operation without external LAN or WLAN;

Central Controller regularly runs diagnostics of the entire system to monitor hardware and schedule preventive maintenance;

Central Controller sends regular diagnostic reports to the cloud for user visibility and longevity predictions;

Scope monitoring camera and microphone are always on and pointed at the system in order to further detect anomalies;

Central Controller performs local live stacking of images during operation;

Central Controller can perform batch processing of images using user provided algorithms;

Central Controller and Secondary Controller communicate to automatically power-cycle devices in the event of anomalies; and/or

Secondary Controller can force power states in the event of weather emergencies or Central Controller failure.

FIGS. 1A-3D illustrate weatherized optical observing systems 100, according to certain embodiments. In some embodiments, materials, components, features, and/or functionality of a weatherized optical observing system 100 of one or more of FIGS. 1A-3D is the same or similar to that of a weatherized optical observing system 100 of one or more of FIGS. 1A-3D. In some embodiments, a weatherized optical observing system 100 of the present disclosure may have materials, components, features, and/or functionality from any combination of FIGS. 1A-3D. The weatherized optical observing system 100 of one or more of FIGS. 1A-3D may have a controller 110 (e.g., edge controller, processing device, processor, etc.).

FIGS. 1A-B illustrate components weatherized optical observing systems 100, according to certain embodiments.

FIGS. 1C-2 illustrate mechanics of the weatherized optical observing systems 100.

FIG. 2 illustrates a system 200 of weatherized optical observing systems 100, according to certain embodiments. In some embodiments, system 200 includes a server device 202 (e.g., controller 110, processing device, etc.) that communicates (e.g., wirelessly, etc.) with weatherized optical observing systems 100 (e.g., ground stations). Each weatherized optical observing system 100 may include one or more of a controller 110 (e.g., edge controller), weather station 140, focusing device 118, rotator 120, gimbal 130, imaging device 122, filter wheel 123, global positioning system (GPS), wireless capabilities (e.g., WiFi®, 5G, local network, etc.), and/or the like. The server device 202 may control the weatherized optical observing systems 100. The server device 202 may receive images from the weatherized optical observing systems 100. Responsive to a weather station 140 of a weatherized optical observing system 100 indicating adverse weather conditions, that weatherized optical observing system 100 may close and a different weatherized optical observing system 100 whose weather station 140 indicates no adverse weather conditions may capture images. Adverse weather conditions may include rain, snow, moisture, threshold dew point, and/or other conditions that may cause moisture to damage one or more components of the weatherized optical observing system 100.

In some embodiments, system 200 includes weatherized optical observing systems 100. Each of the weatherized optical observing systems 100 may include components that include an optical telescope 111 (e.g., including an imaging device 122 configured to capture telescope images), a gimbal 130 configured to move the optical telescope 111 in at least two axes, and a controller 110 (e.g., integrated controller). The controller 110 may be configured to wirelessly transmit the telescope images and wirelessly receive instructions (e.g., from server device 202). System 200 may further include a server device 202 configured to receive the telescope images from the weatherized optical observing systems 100 and wirelessly transmit the instructions to control the plurality of weatherized optical observing systems 100.

FIGS. 3A-D illustrate weatherized optical observing systems 100, according to certain embodiments.

In FIGS. 1C, 3A, 3B, and 3D, the optical telescope 111 may be facing diagonally down towards the weather seal 172. A distal end of the optical telescope 111 may have one or more of a brush, weather strip, gasket, etc. that interfaces with the weather seal 172. The optical telescope 111 may be weighted to face diagonally down towards the weather seal 172 in a home position and/or when power is turned off. The opposite end of the optical telescope 111 may be the weatherized cover 170 that prevents moisture, particles, etc. from entering the optical telescope 111.

In some embodiments, no observatory (e.g., building) is required to use the weatherized optical observing system 100.

The weatherized optical observing system 100 may be an observatory-class instrument (e.g., without the use of an observatory) that is configured to track, monitor, and analyze celestial bodies at a threshold accuracy. The weatherized optical observing system 100 may include optomechanical systems to enhance understanding of the space environment and enable effective navigation through its complexities.

In some embodiments, the weatherized optical observing system 100 may be configured to observe the sky both day and night in some of the harshest environments. The weatherized optical observing system 100 may be configured to automatically capture images in an imaging capturing configuration responsive to no adverse weather conditions and then automatically cease capturing images and seal components from the environment responsive to adverse weather conditions. The weatherized optical observing system 100 may automatically switch between configurations (e.g., taking photos and sealed) as the weather conditions change.

The weatherized optical observing system 100 may have integrated a wide-field optical telescope 111 and a direct-drive gimbal 130 into a multi-purpose, weatherized, and fully remote, deployable telescope system.

In some embodiments, the imaging device 122 (e.g., imaging camera) may capture from about 1.55 to about 2.35 degree field of view.

In some embodiments, the weather station 140 is configured to monitor one or more of temperature, humidity, barometric pressure, precipitation, wind speed, and wind direction.

In some embodiments, all-sky camera 142 may be configured to perform cloud detection (e.g., predict when to be in a sealed configuration, determine when to capture images).

In some embodiments, the weatherized optical observing system 100 includes a location device (e.g., GPS) configured to automatically update the time and pin-point location.

In some embodiments, the base 152 may be a base pier, a rolling pier (e.g., portable rolling pier), or a metal pallet

In some embodiments, the electronics of the weatherized optical observing system 100 that are orchestrated by a controller 110 that allows direct web-based telescope control.

In some embodiments, the weatherized optical observing system 100 may be controlled remotely (e.g., via the cloud, via Starlink, etc.). In some embodiments, internal power over ethernet (PoE) delivers power to support a wireless component (e.g., Starlink Satellite dish).

In some embodiments, the weatherized optical observing system 100 includes built in connectivity via one or more of WiFi®, 5G, and/or long-term evolution (LTE) wireless communication.

In some embodiments, the weatherized optical observing system 100 may include an optical telescope that includes one or more of:

Aperture of about 14 in (356mm);

Focal Length of about 141.34 in (1050 mm);

Focal Ratio of about f/3;

Central Obstruction of about 56% by Primary Mirror Diameter;

Back Focus of about 5.6 inches (142 mm); and/or

Field of View of about 1.55 degrees.

In some embodiments, the weatherized optical observing system 100 may include a gimbal 130 (e.g., gimbal system) that includes one or more of:

Alt-Azimuth/ Equatorial Direct Drive;

Max. Load Capacity of about 300 lbs (136 kg);

Latitude Range of about 0 to 90 degrees, Northern and Southern hemispheres;

Cable Management Equipment cables can be wired through mount; and/or

Slew Rate of about 20 to about 50 degrees/ second (e.g., both axes).

In some embodiments, the weatherized optical observing system 100 has a system performance of one or more of the following:

Pointing Accuracy (all-sky RMS) of about <8-arcsecond RMS with PointXP Model;

Pointing Precision of about 2 arcseconds at sidereal velocity;

Open Loop Tracking Accuracy of about 0.3 arcseconds over a 5-minute period at sidereal velocity;

Power Requirement Accepts about 120 to about 240 VAC (e.g., supplied with 120 VAC 15A IEC Type B regulated power adapter)

In some embodiments, the weatherized optical observing system 100 is all weathered operation from about -20 degrees Celsius to about 50 degrees Celsius with up to about 60 miles per hour (mph) wind.

In some embodiments, the weatherized optical observing system 100 (e.g., controller 110) uses software that performs one or more of plate solving, mount modeling and control, focusing, environmental sensing, with cloud base access, and control of the weatherized optical observing system 100.

FIG. 3C may be in a viewing position, where the optical telescope 111 is pointed upwards (e.g., diagonally upward) and is not against the weather seal.

In some embodiments, a weatherized optical observing system 100 includes components that include an optical telescope 111, a gimbal 130, and a controller 110 (e.g., an integrated controller).

The optical telescope 111 includes an imaging device 122 configured to capture telescope images.

The gimbal 130 is configured to move the optical telescope 111 in at least two axes.

The controller 110 is configured to wirelessly transmit the telescope images, wirelessly receive instructions (e.g., from server device 202, from a processing device, from a smartphone, from a laptop, based on a schedule, etc.), identify local weather data, actuate the gimbal 130 based on the instructions, and control the optical telescope 111 based on at least one of the instructions or the local weather data.

In some embodiments, the components are calibrated prior to the weatherized optical observing system 100 being disposed outside (e.g., on site). In some embodiments, the controller 110 is configured to place one or more of the components in a protected configuration to seal the one or more of the components from moisture responsive to determining adverse weather conditions based on the local weather data.

In some embodiments, the weatherized optical observing system 100 further includes at a weather station 140 including a camera (e.g., all-sky camera 142) configured to capture images associated with at least a portion of the local weather data.

In some embodiments, the weatherized optical observing system 100 further includes a dew point sensor configured to provide at least a second portion of the local weather data.

In some embodiments, the optical telescope 111 includes a positive pressure port 116 configured provide airflow to prevent particles from interfering with the imaging device 122.

In some embodiments, the optical telescope 111 includes an outer cover including one or more gaskets that is configured to automatically seal the imaging device 122 from moisture during adverse weather conditions.

In some embodiments, the optical telescope 111 includes a brush 166 that is configured to prevent the particles from entering the optical telescope 111 responsive to the optical telescope 111 closing during the adverse weather conditions.

In some embodiments, the weatherized optical observing system 100 further includes a controller area network (CAN) bus configured to electrically couple two or more of the plurality of components.

In some embodiments, the gimbal 130 includes a first processing device (e.g., microprocessor), the imaging device 122 comprises a second processing device (e.g., microprocessor), and the focusing device 118 includes a third processing device (e.g., microprocessor). Responsive to failure of the controller 110, the first processing device is to place the gimbal 130 in a first safe state, the second processing device is to place the imaging device 122 in a second safe state, and the third processing device is to place the focusing device 118 in a third safe state (e.g., components self-control themselves to go back to a safe state responsive to not receiving communication from the controller 110). The safe state may be one or more of a shut state, a sealed state, etc.

In some embodiments, the weatherized optical observing system 100 further includes one or more of a dew heater 112, fans, or positive pressure port 116 configured to prevent moisture buildup associated with the weatherized optical observing system 100.

In some embodiments, the weatherized optical observing system 100 further includes a global positioning system (GPS) device configured to provide location data (e.g., of the weatherized optical observing system 100) to the controller 110.

In some embodiments, the gimbal 130 includes at least one of a plurality of gears or a direct drive motor configured to adjust location of the optical telescope 111.

In some embodiments, the optical telescope 111 is weighted to automatically close responsive to power failure.

In some embodiments, the weatherized optical observing system 100 further includes panels and gaskets configured to prevent moisture from entering the weatherized optical observing system 100.

In some embodiments, the weatherized optical observing system 100 further includes a weatherized altitude axis movement component (e.g., of gimbal 130), a weatherized azimuth axis movement component (e.g., of gimbal 130), and a weatherized camera focuser (e.g., focusing device 118).

In some embodiments, each corresponding component includes a corresponding processing device. Each corresponding processing device is configured to place each corresponding component in a protected configuration responsive to lack of communication from the controller 110.

In some embodiments, the optical telescope 111 further includes one or more of: at least one dew heater 112; at least one mirror fan 114; or at least one positive-pressure fan (e.g., coupled to the positive pressure port 116, air dryer 160 coupled to the positive pressure port via air duct 162).

In some embodiments, the optical telescope 111 further includes one or more of: a plurality of lenses; a plurality of mirrors; a weatherization cover configured to automatically cover the imaging device based on the local weather data; a focusing device 118 configured to locate the imaging device 122 in a particular focal plane of the optical telescope 111; a rotator 120 (e.g., de-rotator) configured to correct for field rotation caused by an alt-az (e.g., altitude-azimuth) tracking system tracking equatorial objects; a filter associated with the imaging device; and/or a dehumidifier and positive air-flow fan system configured to maintain optics clean and to prevent dew from being on one or more of the plurality of mirrors.

In some embodiments, the weatherized optical observing system 100 further includes at least one of: a secondary controller configured to switch on and off the one or more components; and/or an optical controller configured to control one or more of the dehumidifier and the positive air-flow system, the rotator 120 (e.g., de-rotator), the focusing device 118, optical tube assembly (OTA) fans (e.g., air dryer 160), or the at least one dew heater 112.

In some embodiments, the weatherized optical observing system 100 further includes at least one of: a weather seal 172 (e.g., home position weather seal; or a base 152 (e.g., a steel pallet base).

In some embodiments, the weatherized optical observing system 100 includes one or more of: an air duct 162 coupled between an air dryer 160 and a positive pressure port 116; or a weatherized optical tube assembly (OTA) 164.

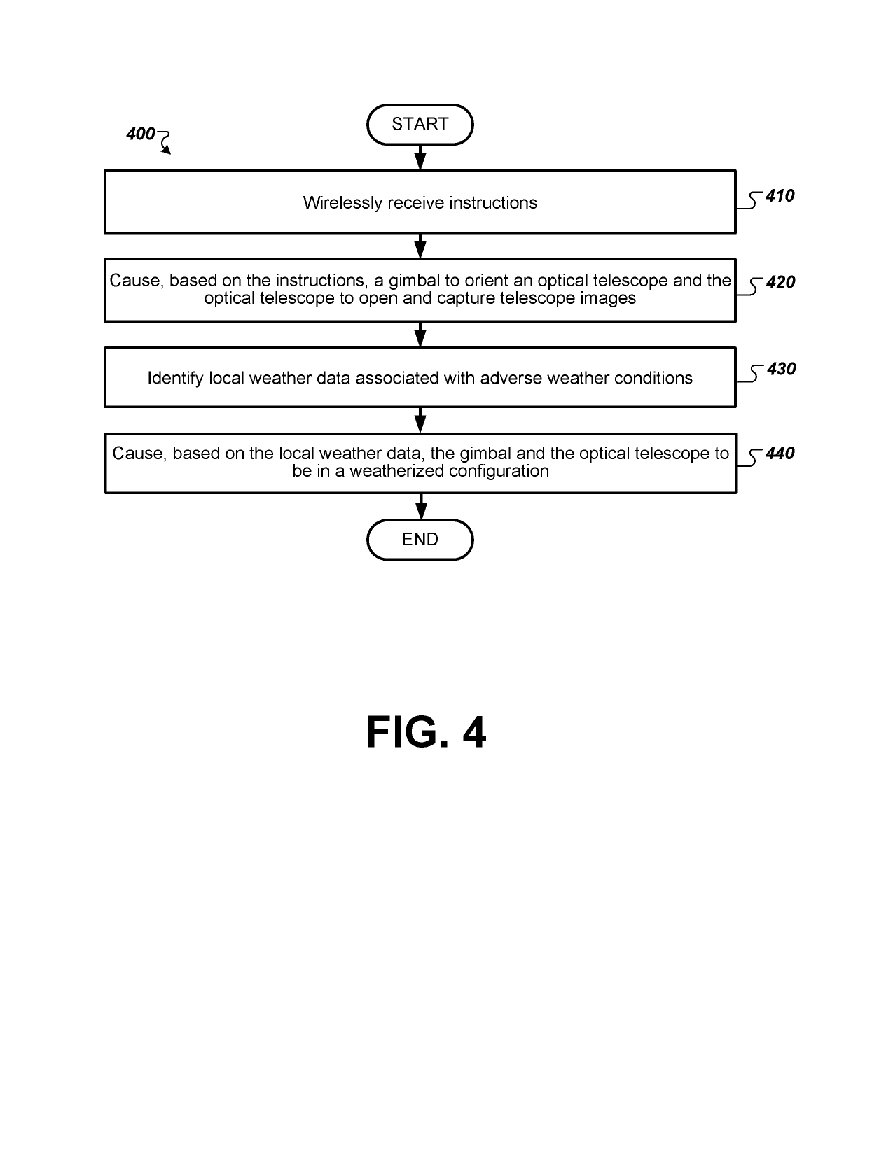

FIG. 4 is a flow chart of a method 400 associated with a weatherized optical observing system (e.g., weatherized optical observing system 100 of one or more of FIGS. 1A-D), according to certain embodiments. In some embodiments, method 400 is performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 400 is performed, at least in part, by controller 110. In some embodiments, a non-transitory machine-readable storage medium stores instructions that when executed by a processing device (e.g., of controller 110), cause the processing device to perform method 400.

For simplicity of explanation, method 400 is depicted and described as a series of operations. However, operations in accordance with this disclosure can occur in various orders and/or concurrently and with other operations not presented and described herein. Furthermore, in some embodiments, not all illustrated operations are performed to implement method 400 in accordance with the disclosed subject matter. In addition, those skilled in the art will understand and appreciate that method 400 could alternatively be represented as a series of interrelated states via a state diagram or events.

At block 410, processing logic wirelessly receives, by an integrated controller of a weatherized optical observing system, instructions.

At block 420, processing logic causes , by the integrated controller based on the instructions, a gimbal of the weatherized optical observing system to orient an optical telescope of the weatherized optical observing system and the optical telescope to open and capture telescope images.

At block 430, processing logic identifies, by the integrated controller, local weather data associated with adverse weather conditions.

At block 440, processing logic causes, by the integrated controller based on the local weather data, the gimbal and the optical telescope to be in a weatherized configuration.

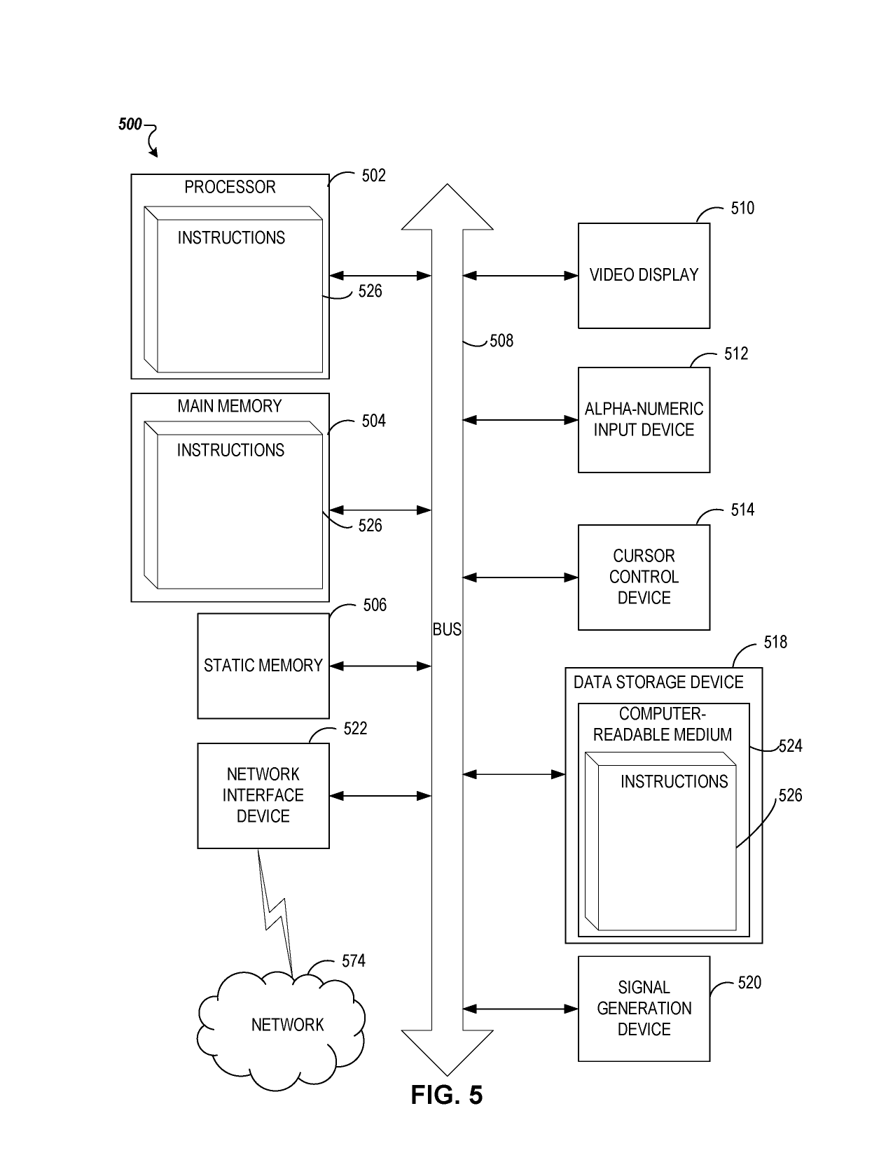

FIG. 5 is a block diagram illustrating a computer system 500, according to certain embodiments. In some embodiments a weatherized optical observing device (e.g., of one or more of FIGS. 1A-3D) includes computer system 500. Computer system 500 and/or processor 502 may be controller 110 of one or more of FIGS. 1A-3D.

In some embodiments, computer system 500 is connected (e.g., via a network, such as a Local Area Network (LAN), an intranet, an extranet, or the Internet) to other computer systems. In some embodiments, computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term "computer" shall include any collection of computers that individually or jointly execute a set (or multiple sets) of instructions to perform any one or more of the methods described herein.

In a further aspect, the computer system 500 includes a processing device 502, a volatile memory 504 (e.g., Random Access Memory (RAM)), a non-volatile memory 506 (e.g., static memory 506, Read-Only Memory (ROM), or Electrically-Erasable Programmable ROM (EEPROM)), and a data storage device 516, which communicate with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500 further includes a network interface device 522 (e.g., coupled to network 574). In some embodiments, computer system 500 also includes a video display unit 510 (e.g., an LCD), an alphanumeric input device 512 (e.g., a keyboard), a cursor control device 514 (e.g., a mouse), and a signal generation device 520.

In some implementations, data storage device 516 includes a non-transitory computer-readable storage medium 524 on which store instructions 526 encoding any one or more of the methods or functions described herein, including instructions for implementing methods described herein.

In some embodiments, instructions 526 also reside, completely or partially, within volatile memory 504 and/or within processing device 502 during execution thereof by computer system 500, hence, in some embodiments, volatile memory 504 and processing device 502 also constitute machine-readable storage media.

While computer-readable storage medium 524 is shown in the illustrative examples as a single medium, the term "computer-readable storage medium" shall include a single medium or multiple media (e.g., a centralized or distributed database, and/or associated caches and servers) that store the one or more sets of executable instructions. The term "computer-readable storage medium" shall also include any tangible medium that is capable of storing or encoding a set of instructions for execution by a computer that cause the computer to perform any one or more of the methods described herein. The term "computer-readable storage medium" shall include, but not be limited to, solid-state memories, optical media, and magnetic media.

In some embodiments, the methods, components, and features described herein are implemented by discrete hardware components or are integrated in the functionality of other hardware components such as ASICs, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “receiving,” “causing,” “training,” “generating,” “providing,” “obtaining,” “interrupting,” “determining,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms "first," "second," "third," "fourth," etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein or includes a general-purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms "first," "second," "third," "fourth," etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ± 10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A weatherized optical observing system comprising:
a plurality of components comprising:
an optical telescope comprising an imaging device configured to capture telescope images;
a gimbal configured to move the optical telescope in at least two axes; and
an integrated controller configured to:
wirelessly transmit the telescope images;
wirelessly receive instructions;
identify local weather data;
actuate the gimbal based on the instructions; and
control the optical telescope based on at least one of the instructions or the local weather data.

2. The weatherized optical observing system of claim 1, wherein:
the plurality of components are calibrated prior to the weatherized optical observing system being disposed outside; and
the integrated controller is configured to place one or more of the plurality of components in a protected configuration to seal the one or more of the plurality of components from moisture responsive to determining adverse weather conditions based on the local weather data.

3. The weatherized optical observing system of claim 1 further comprising at least one of:
a weather station comprising a camera configured to capture a plurality of images associated with at least a portion of the local weather data; or
a dew point sensor configured to provide at least a second portion of the local weather data.

4. The weatherized optical observing system of claim 1, wherein the optical telescope comprises at least one of:
a positive pressure port configured provide airflow to prevent particles from interfering with the imaging device;
an outer cover comprising one or more gaskets that is configured to automatically seal the imaging device from moisture during adverse weather conditions; or
a brush that is configured to prevent the particles from entering the optical telescope responsive to the optical telescope closing during the adverse weather conditions.

5. The weatherized optical observing system of claim 1 further comprising a controller area network (CAN) bus configured to electrically couple two or more of the plurality of components.

6. The weatherized optical observing system of claim 1, wherein:
the gimbal comprises a first processing device;
the imaging device comprises a second processing device;
a focusing device of the optical telescope comprise a third processing device; and
responsive to failure of the integrated controller, the first processing device is to place the gimbal in a first safe state, the second processing device is to place the imaging device in a second safe state, and the third processing device is to place the focusing device in a third safe state.

7. The weatherized optical observing system of claim 1 further comprising one or more of a dew heater, fans, or positive pressure port configured to prevent moisture buildup associated with the weatherized optical observing system.

8. The weatherized optical observing system of claim 1 further comprising a global positioning system (GPS) device configured to provide location data to the integrated controller.

9. The weatherized optical observing system of claim 1, wherein the gimbal comprises at least one of a plurality of gears or a direct drive motor configured to adjust location of the optical telescope.

10. The weatherized optical observing system of claim 1, wherein the optical telescope is weighted to automatically close responsive to power failure.

11. The weatherized optical observing system of claim 1 further comprising a plurality of panels and a plurality of gaskets configured to prevent moisture from entering the weatherized optical observing system.

12. The weatherized optical observing system of claim 1 further comprising a weatherized altitude axis movement component, a weatherized azimuth axis movement component, and a weatherized camera focuser.

13. The weatherized optical observing system of claim 1, wherein each corresponding component of the plurality of components comprises a corresponding processing device, wherein each corresponding processing device is configured to place each corresponding component in a protected configuration responsive to lack of communication from the integrated controller.

14. The weatherized optical observing system of claim 1, wherein the optical telescope further comprises one or more of:
at least one dew heater;
at least one mirror fan; or
at least one positive-pressure fan.

15. The weatherized optical observing system of claim 14, wherein the optical telescope further comprises one or more of:
a plurality of lenses;
a plurality of mirrors;
a weatherization cover configured to automatically cover the imaging device based on the local weather data;
a focusing device configured to locate the imaging device in a particular focal plane of the optical telescope;
a de-rotator configured to correct for field rotation caused by an alt-az tracking system tracking equatorial objects;
a filter associated with the imaging device; or
a dehumidifier and positive air-flow fan system configured to maintain optics clean and to prevent dew from being on one or more of the plurality of mirrors.

16. The weatherized optical observing system of claim 15 further comprising at least one of:
a secondary controller configured to switch on and off the one or more components; or
an optical controller configured to control one or more of the dehumidifier and the positive air-flow system, the de-rotator, the focusing device, optical tube assembly (OTA) fans, or the at least one dew heater.

17. The weatherized optical observing system of claim 1 further comprising at least one of:
a home position weather seal; or
a steel pallet base.

18. The weatherized optical observing system of claim 1 further comprising one or more of:
an air duct coupled between an air dryer and a positive pressure port; or
a weatherized optical tube assembly (OTA).

19. A system comprising:
a plurality of weatherized optical observing systems, wherein each of the plurality of weatherized optical observing systems comprises:
a plurality of components comprising:
an optical telescope comprising an imaging device configured to capture telescope images;
a gimbal configured to move the optical telescope in at least two axes; and
an integrated controller configured to wirelessly transmit the telescope images and wirelessly receive instructions; and
a server device configured to receive the telescope images from the plurality of weatherized optical observing systems and wirelessly transmit the instructions to control the plurality of weatherized optical observing systems.

20. A method comprising:
wirelessly receiving, by an integrated controller of a weatherized optical observing system, instructions;
causing, by the integrated controller based on the instructions, a gimbal of the weatherized optical observing system to orient an optical telescope of the weatherized optical observing system and the optical telescope to open and capture telescope images;
identifying, by the integrated controller, local weather data associated with adverse weather conditions; and
causing, by the integrated controller based on the local weather data, the gimbal and the optical telescope to be in a weatherized configuration.
